(19) United States
(12) Patent Application Publication
(10) Pub. No.: US 2004/0109070 A1
(43) Pub. Date: Jun. 10, 2004

(54) Image signal processing system

(76) Inventor: Duck Young Jung, Yongin-city (KR)

Correspondence Address: CANTOR COLBURN LLP, 55 Griffin Road South, Bloomfield, CT, 06002, US

(21) Appl. No.: 10/727,786

(22) Filed: Dec. 4, 2003

(30) Foreign Application Priority Data
Dec. 5, 2002 (KR) 2002-77097

(51) Int. Cl. H04N 5/235; G03B 7/00

(52) U.S. Cl. 348/230.1; 348/362

(57) ABSTRACT

Disclosed is an image signal processing system, which comprises an image sensor for receiving an image of a subject in a light form under the control of a shutter control signal to generate analog signals, a direct current offset controller for controlling direct current offsets of output signals of the image sensor under the control of an offset control signal, a variable gain amplifier for amplifying output signals of the direct current offset controller under the control of a gain control signal to maximize dispersion of the output signals, a first A/D converter for receiving the output signals of the variable gain amplifier and converting the received output signals into digital signals, a second A/D converter for receiving the output signals of the image sensor and converting the received output signals into the digital signals, and an image data processor for receiving the output signals of the first A/D converter and the output signals of the second A/D converter to find a movement value and generating the gain control signal, the offset control signal and the shutter control signal, whereby it is possible to maximize the dispersion of the signals inputted into the image data processor, thus to increase accuracy and reliability.

### CROSS-REFERENCE TO RELATED APPLICATION

This application claims the benefit of Korean Patent Application No. 2002-77097, filed Dec. 5, 2002, the disclosure of which is hereby incorporated herein by reference in its entirety.

### BACKGROUND OF THE INVENTION

1. Field of the Invention

The present invention relates to an image signal processing system and, more particularly, to an image signal processing system capable of maximizing dispersion of output signals.

2. Description of the Related Art

FIG. 1 is an internal block diagram illustrating a conventional image signal processing system.

As shown, the conventional image signal processing system is designed so that, when light radiated from a light source (not shown) is reflected by a subject and then is incident onto an image sensor 11, each pixel of the image sensor 11 composed of N×N pixel array generates an analog signal corresponding to a brightness of an image region thereof.

Here, a shutter controller 14 controls an exposure time of the image sensor 11 so that a quantity of light incident onto the image sensor 11 is not saturated.

The analog signal generated by the image sensor 11 is converted into a digital signal by an A/D converter 12 and is provided to an image data processor 13. The image data processor 13 processes the digital signal converted by the A/D converter 12 and then generates and outputs various control signals.

The conventional image signal processing system operated in this manner is widely used to obtain a variety of images of the subject to calculate movement values.

However, as for the conventional image signal processing system, an exact image of the subject can be obtained when dispersion of light reflected from the subject is wide, but the exact image of the subject can not be obtained when the dispersion of the light reflected from the subject is narrow.

The case that the dispersion of the light is narrow means that a brightness difference between each image region of the subject is small and thus a voltage difference between output signals corresponding to the brightness of each image region is small. The case that the dispersion of the light is wide means that a contrast difference between each image region of the subject is large and thus the voltage difference between the output signals corresponding to the brightness of each image region is large.

In other words, in case of obtaining a shape of the image of the subject using output signals received by the image data processor, when the received output signals have narrow dispersion, the brightness difference between each image region is not exactly discriminated, and thus it is difficult to exactly recognize the shape of the image of the subject.

Thus, the conventional image signal processing system has a problem in that, when the dispersion of the light reflected from the subject is narrow, it can not exactly recognize the shape of the image of the subject, and thus caussing wrong operations.

### SUMMARY OF THE INVENTION

It is, therefore, an object of the present invention to provide an image signal processing system capable of providing accuracy and reliability of system operation by maximizing dispersion of output signals.

In order to accomplish this object, according to one aspect of the present invention, there is provided an image signal processing system comprising an image sensor for receiving an image of a subject in a light form under the control of a shutter control signal to generate analog signals, a variable gain amplifier for amplifying output signals of the image sensor under the control of a gain control signal to maximize dispersion of the analog signals, a first A/D converter for receiving the output signals of the variable gain amplifier and converting the received output signals into digital signals, a second A/D converter for receiving the output signals of the image sensor and converting the received output signals into the digital signals, and an image data processor for receiving the output signals of the first A/D converter and the output signals of the second A/D converter to find a movement value and generating the gain control signal and the shutter control signal.

In order to accomplish this object, according to another aspect of the present invention, there is provided an image signal processing system comprising an image sensor for receiving an image of a subject in a light form under the control of a shutter control signal to generate analog signals, a direct current offset controller for controlling direct current offsets of output signals of the image sensor under the control of an offset control signal, a variable gain amplifier for amplifying output signals of the direct current offset controller under the control of a gain control signal to maximize dispersion of the output signals, a first A/D converter for receiving the output signals of the variable gain amplifier and converting the received output signals into digital signals, a second A/D converter for receiving the output signals of the image sensor and converting the received output signals into the digital signals, and an image data processor for receiving the output signals of the first A/D converter and the output signals of the second A/D converter to find a movement value and generating the gain control signal, the offset control signal and the shutter control signal.

Here, the shutter control signal of the image signal processing system is generated by processing the output signals of the second A/D converter.

Here, the variable gain amplifier of the image signal processing system is a sample-and-hold amplifier having a gain-control capacitor array or a resistance array for controlling a gain value.

Here, the second A/D converter of the image signal processing system is configured of a plurality of analog comparators.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram illustrating a conventional image signal processing system;

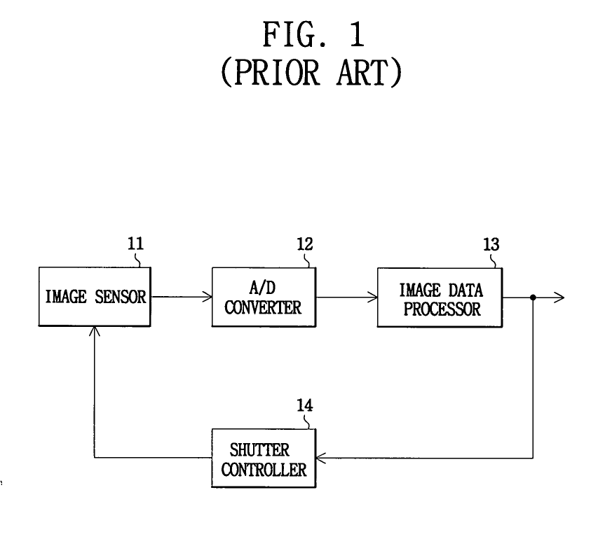

FIG. 2 is a block diagram illustrating an image signal processing system according to a first embodiment of the present invention; and

FIG. 3 is a block diagram illustrating an image signal processing system according to a second embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout the specification.

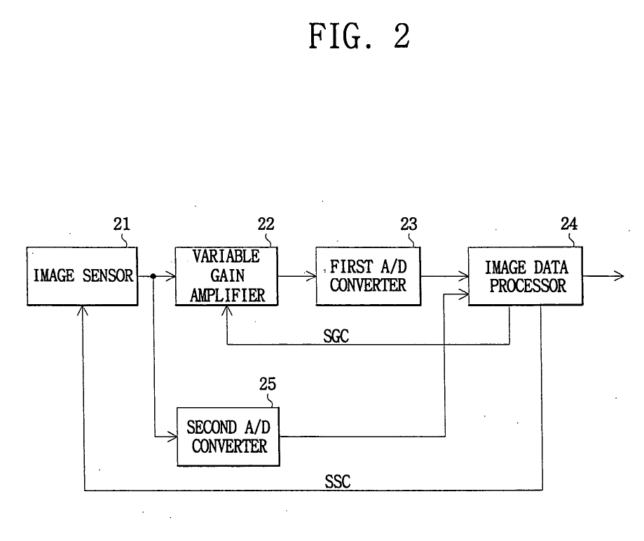

FIG. 2 is a block diagram illustrating an image signal processing system according to a first embodiment of the present invention.

Referring to FIG. 2, the image signal processing system of the present invention includes an image sensor 21, a variable gain amplifier 22, a first A/D converter 23, an image data processor 24 and a second A/D converter 25.

The image sensor 21 obtains a two-dimensional image of a subject through a plurality of pixels under the control of a shutter control signal SSC, wherein each pixel generates an analog signal having a voltage value corresponding to a brightness of an image region thereof.

Further, the image sensor 21 outputs the plurality of analog signals, which are generated through the plurality of pixels, to the outside.

The variable gain amplifier 22 controls a gain using a gain control signal SGC applied from the image data processor 24, amplifies the plurality of analog signals received from the image sensor 21 by the controlled gain, and then outputs the amplified results. As a result, dispersion of the output signals of the image sensor 21 is maximized.

In this case, as the variable gain amplifier 22, there may be used a sample-and-hold amplifier having a gain-control capacitor array or a resistance array for controlling a gain value in response to the gain control signal SGC.

The first A/D converter 23 receives the analog signals amplified from the variable gain amplifier 22, converts the received analog signals into m-bit digital signals corresponding to voltage values of the amplified analog signals, and provides the converted results to the image data processor 24.

The second A/D converter 25 receives the analog signals from the image sensor 21, converts the received analog signals into n-bit digital signals corresponding to voltage values of the received analog signals, and provides the converted results to the image data processor 24.

Here, the second A/D converter 25 is provided to operate independently of the first A/D converter 23. This is because an unprocessed output value of the image sensor 25 is needed when the image data processor 24 generates the shutter control signal SSC.

At this time, since the second A/D converter 25 would simply need to provide only information on a quantity of light incident onto the image sensor to the image data processor 24, the second A/D converter does not require high performance. Therefore, as the second A/D converter 25, an A/D converter consisting of a plurality of analog comparators may be used.

The image data processor 24 checks the image of the subject inputted currently using output signals outputted from the first A/D converter 23, compares the checked image with the image of the subject inputted previously, calculates a movement value of the subject, and outputs the calculated movement value to the outside.

Further, the image data processor 24 generates the gain control signal SGC for allowing the dispersion of the output signals of the first A/D converter 23 to be checked and maximized the dispersion at any time, and provides the generated gain control signal SGC to the variable gain amplifier 22.

Furthermore, the image data processor 24 generates the shutter control signal SSC using the output signals of the second A/D converter 25, and provides the generated shutter control signal SSC to the image sensor 21.

The shutter control signal SSC controls an exposure time of the image sensor 21 to allow the image sensor 21 to obtain an exact image of the subject.

Description of operation of the image signal processing system of FIG. 2 configured in this manner is as follows.

The image data processor 24 generates the gain control signal SGC using the m-bit digital signals outputted from the previous first A/D converter 23 and provides the generated gain control signal SGC to the variable gain amplifier 22, and also generates the shutter control signal SSC using the n-bit digital signals outputted from the second A/D converter 25 and provides the generated shutter control signal SSC to the image sensor 21.

Thus, the image sensor 21 responds to the shutter control signal SSC to control the exposure time thereof, while the variable gain amplifier 22 responds to the gain control signal SGC to control the gain thereof.

When a shutter on period becomes according to the controlled exposure time in this state, each pixel of the image sensor 21 receives the light, which is reflected and incident from the subject, to generate the analog signal having the voltage value proportional to the received quantity of light.

The image sensor 21 provides the plurality of analog signals generated through the plurality of pixels to the variable gain amplifier 22 and the second A/D converter 25.

The variable gain amplifier 22 amplifies each of the analog signals by the controlled gain, and outputs the amplified results to the first A/D converter 23. Thus, the analog signals of the image sensor 21 have maximized dispersion.

The first A/D converter 23 receives the plurality of analog signals having the maximized dispersion and converts each of the analog signals into the m-bit digital signal. The image data processor 24 obtains a current image of the subject using the plurality of m-bit digital signals transmitted from the first A/D converter 23.

The image data processor 24 obtaining the current image of the subject finds a correlation between the current image of the subject and the previous image of the subject to calculate a movement value V(K), and then outputs the calculated movement value V(K).

Further, in order to receive the output signals having the maximized dispersion, the image data processor 24 generates a new gain control signal SGC having a new value with the use of the m-bit digital signals transmitted from the first A/D converter 23, and re-transmits the generated result to the variable gain amplifier 22. Further, the image data processor 24 generates a new shutter control signal SSC having a new value with the use of the n-bit digital signals of the second A/D converter 25, and re-transmits the generated result to the image sensor 21.

In this manner, the image signal processing system configured as in FIG. 2 is used under the condition of capable of controlling a shutter through the variable gain amplifier, thus maximizing the dispersion of the output signals.

In view of the characteristics of the circuit, the variable gain amplifier is generally restricted to a voltage range that is capable of normally sensing and amplifying.

Thus, the image signal processing system configured as in FIG. 2 has a problem in that, when the image signal processing system is used under the low or high luminance condition and thus the output signals outputted from the image sensor have voltages beyond the voltage range which the variable gain amplifier is capable of normally sensing and amplifying, the variable gain amplifier can not normally perform the amplification operation.

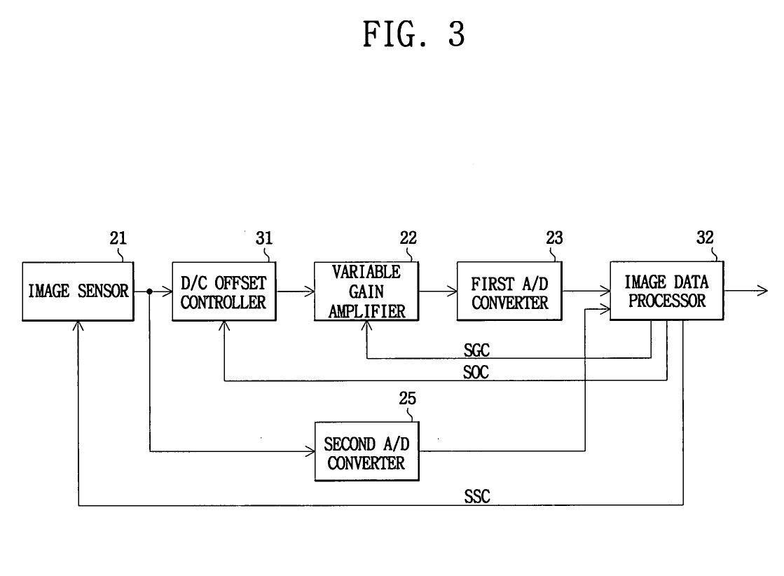

The following image signal processing system shown in FIG. 3 in accordance with a second embodiment of the present invention is a scheme for solving the foregoing problem.

FIG. 3 is a block diagram illustrating the image signal processing system according to the second embodiment of the present invention. Similarly to the image signal processing system of FIG. 2, the image signal processing system of FIG. 3 also includes the image sensor 21, the variable gain amplifier 22, the first A/D converter 23, the image data processor 32 and the second A/D converter 25, but it further includes a DC offset controller 31.

Therefore, in the circuit of FIG. 3, elements having the same configuration and operation as those of the circuit of FIG. 2 will be equally numbered as in FIG. 2, and their detailed descriptions will be omitted.

The DC offset controller 31 responds to a DC offset control signal SOC provided from the image data processor 32 to control DC offsets of each output signal of the image sensor 21.

Thus, the variable gain amplifier 23 receives and amplifies the output signals of the image sensor 21 which have the controlled DC offsets.

The image data processor 32 checks a current input image of the subject using the m-bit digital signals of the first A/D converter 23, finds a correlation between the current image of the subject and the previous image of the subject to calculate a movement value of the subject, and then outputs the calculated movement value to the outside.

Further, the image data processor 32 responds the m-bit digital signals of the first A/D converter 23 to generate the gain control signal SGC.

Furthermore, the image data processor 32 generates an offset control signal SOC for making it possible for the output signals from the first A/D converter 23 to determine a voltage range and to be existed within the voltage range which the variable gain amplifier 22 is capable of normally sensing and amplifying, and applies the generated offset control signal SOC to the DC offset controller 31.

Therefore, the output signals outputted from the image sensor always exist within the voltage range which the variable gain amplifier is capable of normally sensing and amplifying, and thus the variable gain amplifier can normally perform amplification operation.

With this configuration, the image signal processing system of the present invention maximizes the dispersion of the output signals under any condition.

Although preferred embodiments of the present invention have been described for illustrative purposes, those skilled in the art will understand that various modifications, additions and substitutions are possible, without departing from the scope and spirit of the invention as disclosed in the accompanying claims.

As can be seen from the foregoing, the image signal processing system according to the present invention includes the variable gain amplifier for amplifying the output signals of the image sensor, and further includes the first A/D converter for converting the amplified signals into the digital signals as well as the second A/D converter for directly receiving the output signals of the image sensor to convert the received output signals into the digital signals, so that it is possible to maximize the dispersion of the signals inputted into the image data processor. Accordingly, the image signal processing system of the present invention can always obtain the exact image of the subject, thus increasesing accuracy and reliability.

Further, the image signal processing system of the present invention additionally includes the DC offset controller at the former terminal of the variable gain amplifier, so that it is possible to maximize the dispersion of the signals inputted into the system under the low or high luminance environment.

What is claimed is:

1. An image signal processing system comprising:
an image sensor for receiving an image of a subject in a light form under the control of a shutter control signal to generate analog signals;
a variable gain amplifier for amplifying output signals of the image sensor under the control of a gain control signal to maximize dispersion of the analog signals;
a first A/D converter for receiving the output signals of the variable gain amplifier and converting the received output signals into digital signals;
a second A/D converter for receiving the output signals of the image sensor and converting the received output signals into the digital signals; and
an image data processor for receiving the output signals of the first A/D converter and the output signals of the second A/D converter to find a movement value and generating the gain control signal and the shutter control signal.

2. The image signal processing system as claimed in claim 1, wherein the shutter control signal is generated by using the output signals of the second A/D converter.

3. The image signal processing system as claimed in claim 1, wherein the variable gain amplifier is a sample-and-hold amplifier architecture.

4. The image signal processing system as claimed in claim 1, wherein the second A/D converter is configured of a plurality of analog comparators.

5. An image signal processing system comprising:
an image sensor for receiving an image of a subject in a light form under the control of a shutter control signal to generate analog signals;
a direct current offset controller for controlling direct current offsets of output signals of the image sensor under the control of an offset control signal;
a variable gain amplifier for amplifying output signals of the direct current offset controller under the control of a gain control signal to maximize dispersion of the output signals;
a first A/D converter for receiving the output signals of the variable gain amplifier and converting the received output signals into digital signals;
a second A/D converter for receiving the output signals of the image sensor and converting the received output signals into the digital signals; and
an image data processor for receiving the output signals of the first A/D converter and the output signals of the second A/D converter to find a movement value and generating the gain control signal, the offset control signal and the shutter control signal.

6. The image signal processing system as claimed in claim 5, wherein the shutter control signal is generated by the output signals of the second A/D converter.

7. The image signal processing system as claimed in claim 5, wherein the variable gain amplifier is a sample-and-hold amplifier architecture.

8. The image signal processing system as claimed in claim 5, wherein the second A/D converter is configured of a plurality of analog comparators.
